(19) United States
(12) Patent Application Publication
(10) Pub. No.: US 2006/0162266 A1
(43) Pub. Date: Jul. 27, 2006

(54) Durable shutter and method for its production

(76) Inventor: Henry M. Hay III, Charleston, SC (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/315,079

(22) Filed: Dec. 22, 2005

Related U.S. Application Data
(60) Provisional application No. 60/639,347, filed on Dec. 27, 2004.

(51) Int. Cl. E06B 3/26

(52) U.S. Cl. 52/202

(57) ABSTRACT

Raised panel, louvered and Bahama shutters can be produced that have two stiles and either a central panel or louvers. The shutters are free of separate support members.

### CROSS REFERENCE TO RELATED PATENTS AND PATENT APPLICATIONS

The present application is a non-provisional of U.S. Provisional Patent Application Ser. No. 60/639,347, filed Dec. 27, 2004, which is hereby incorporated herein by reference in its entirety.

### BACKGROUND OF THE INVENTION

(1). Field of the Invention

The present invention relates to shutters, and more particularly to durable shutters for windows, doors, and the like, and methods for their production.

(2). Description of the Related Art

Shutters are important building components for houses and other structures and are often used for protection or decoration of windows, doors, or other structural openings. Among the many types of shutter designs that are commonly used are colonial (raised panel), Bahama, board and batten, and louvered.

Early shutters were usually constructed entirely of wood. However, wood shutters need to be repainted relatively often, they have low resistance to warpage, rot and insect attack, and they lack fire resistance, among other disadvantages. As building techniques and materials developed, shutters were constructed of metal (See U.S. Pat. Nos. 4,248,022, 5,737,874, 5,907,929, 6,536,174 and 6,543,188), or plastic (See U.S. Pat. No. 4,858,400). Materials such as filled plastics and foamed plastics were also used.

Furthermore, construction and assembly techniques developed around the use of the new materials. For example, shutters were constructed from members that were molded or extruded from a polymer (U.S. Pat. Nos. 5,152,116, 5,255,486 and 5,848,505), or from polymeric components and having an added support member, which is often metal, to provide rigidity (U.S. Pat. Nos. 6,470,639 and 6,820,385).

Despite this progress, however, there remains a need for shutters that are durable, resistant to fire, rot and insect damage, require low maintenance, have a high strength-to-weight ratio, and resist corrosion. It would also be useful if such environmentally friendly shutters could be fabricated in any required size and from a low number of separate component parts. Moreover, it would be useful if such shutters could be assembled in a short time and with few specially designed pieces of equipment. It would also be useful if such shutters could be provided that had high dimensional stability without the use of separate support members, and in particular, without the use of separate metal support members.

### SUMMARY OF THE INVENTION

Briefly, therefore the present invention is directed to a novel shutter comprising two stiles that are spaced apart and a plurality of louvers and/or one or more panels or rails that interconnect the stiles.

The present invention is also directed to a novel shutter consisting essentially of two spaced apart stiles which are interconnected by a plurality of louvers and/or one or more panels or rails.

The present invention is also directed to a novel method of making a shutter comprising the steps: providing two stiles each having the length that is planned for the shutter; providing a panel having the length that is planned for the shutter and a width that is less than that planned for the shutter; and affixing a stile along each side of the panel with an adhesive.

The present invention is also directed to a novel method of using one or more shutters as described in claim 1 for the protection of an opening in a building, the method comprising mounting to the building one or more of said shutters in a position so that they can be closed to cover the opening.

Among the several advantages found to be achieved by the present invention, therefore, may be noted the provision of a shutter that is durable, resistant to fire, rot and insect damage, requires low maintenance, has a high strength-to-weight ratio, and is corrosion resistant, and the provision of such a shutter that can be fabricated in any required size and from a low number of separate component parts, and also the provision of such a shutter that can assembled in a short time and with few specially designed pieces of equipment, and the provision of such a shutter that has high dimensional stability without the use of separate support members, and in particular, without the use of separate metal support members.

### BRIEF DESCRIPTION OF THE DRAWINGS

FIG. 1 shows perspective views of three typical shutter types, where FIG. 1A illustrates a colonial, or raised panel shutter, FIG. 1B illustrates a louvered shutter, and FIG. 1C illustrates a Bahama shutter;

FIG. 2A shows a top elevation view of an embodiment of a stile of the present invention, FIG. 2B shows a right-side elevation view, and FIG. 2C shows a front elevation view of the stile;

FIG. 3A shows a partial cross-sectional view of an embodiment of a raised panel shutter of the present invention generally through location A-A′ as indicated in FIG. 1A, and FIG. 3B shows an end view of a corner of the same type of shutter and illustrates the stile screw support filler and the stile lip end filler that optionally fill void areas at the end of the stile; FIG. 3C illustrates a partial cross-section of one side of an embodiment of a shutter of the present invention showing the presence of an additional durable panel, such as for hurricane protection, along the back of the panel of the shutter; and FIG. 3D is a partial cross-sectional view of an embodiment of a raised panel shutter of the present invention generally through location A-A′ as indicated in FIG. 1A in which the stile is designed to lock directly into a groove machined into the back of the shutter panel so that no lock is required;

FIG. 4 illustrates the insertion of an edge of a panel of an embodiment of a shutter of the present invention into a stile, where A is an exploded view showing the stile and the panel prior to engagement, and B shows the engaged panel and stile, here, without a stop in place;

FIG. 5 is a cross-sectional view of an embodiment of a stile of the present invention into which has been inserted a stile louver filler designed for use in the construction of Bahama or louvered shutters;

FIG. 6 is a partial view of an embodiment of a stile of the present invention having a stile louver filler designed for use in the construction of Bahama or louvered shutters taken roughly through location B-B′ as indicated in FIG. 1B and illustrating louver grooves cut into the stile and the filler, but not showing the louvers;

FIG. 7 illustrates an end view of a corner of a Bahama or louvered shutter embodiment of the present invention and illustrates the presence of a stile screw support filler and stile lip end filler that can be used to fill void areas at the end of the stile, and the presence of a horizontal rail at the end and one or more louvers;

FIG. 8 illustrates a partial cross-section of one side of a louvered or Bahama shutter embodiment of the present invention for storm shutter service showing a louver having a pre-cut bevel at one end that is designed to provide a snap fit into the stile, and also showing a durable panel on the back of the shutter;

FIG. 9 shows a partial cross-section of a side of a louvered or Bahama shutter embodiment of the present invention showing a louver having a pre-cut bevel at one end that is designed to provide a snap-fit into the stile and having a panel stop inserted to lock the louvers in place;

FIG. 10A shows a side elevation view of an embodiment of a raised panel lock of the present invention, and FIG. 10B shows a partial cross-section view of an embodiment of a raised panel shutter of the present invention through location A-A′ as indicated in FIG. 1A, and showing the location of the installed raised panel lock;

FIG. 11 illustrates steps involved in an embodiment of a method of the present invention for the assembly of a shutter;

FIG. 12 illustrates an embodiment of a raised panel shutter of the present invention having a hurricane bar; and

FIG. 13 illustrates an embodiment of a raised panel shutter of the present invention having a protective panel covering the back of the shutter.

Corresponding reference characters indicate corresponding parts throughout the several views of the drawings.

### DETAILED DESCRIPTION OF THE PREFERRED EMBODIMENTS

In accordance with the present invention, it has been discovered that a durable shutter can be produced easily and quickly and with a minimum of waste by using novel materials of construction and a unique design. In particular, a raised panel shutter of the present invention can be produced from only three main components: two vertical side members, or stiles, and a central panel interconnecting the stiles.

Additional parts that optionally can be used to produce a finished shutter include only four stile screw support fillers, four stile lip end fillers, a suitable adhesive and two raised panel stops (which can be referred to herein as “stops”). The present shutter can be made in almost any practical length or width, and can be fabricated with reduced labor and in a reduced amount of time relative to the labor and time required for the construction of shutters of similar overall appearance by conventional methods.

When it is desired to produce a Bahama or fixed louvered shutter, the same stile members can be used, and a stile louver filler is inserted in each stile. When the stile louver filler is in place, louver grooves can be cut. Upon the insertion and gluing of rails, louvers, stile screw support fillers and stile lip end fillers, the shutter assembly is completed.

The inventor has found that the selection of a suitable material of construction for each part of the shutter has made possible the fabrication of durable and attractive shutters with a minimum of waste and a significant reduction in labor. For example, in contrast to a shutter stile that requires the use of a separate support member, usually a metal bar, angle, rod, or tube, such as is shown, for example, in U.S. Pat. Nos. 6,470,639 and 5,848,505, the preferred present stile can be of one-piece pultruded fiberglass construction and preferably is free of any type of separate support member, as discussed in detail below. In preferred embodiments, the same pultruded fiberglass material can be used to produce superior louvers for use in louvered or Bahama-type shutters.

Furthermore, the inventor has found that the central panel of colonial, or raised panel-type shutters is preferably produced from a wood-filled composite plastic board, and a wood-filled cellular PVC is more preferred. The same material is preferred for use in constructing the stile screw support filler, the stile lip end filler, and the stop members of the shutter as well.

The inventor of the present shutter and method of making the shutter has discovered that the combination of the preferred materials of construction and the present design provides a shutter that is durable, resistant to fire, rot and insect damage, requires low maintenance, has a high strength-to-weight ratio and is corrosion resistant. As described briefly above, the present shutters can be fabricated in any required size and from few separate component parts. Moreover, the shutters can be assembled in a short time and with few specially designed pieces of equipment.

As mentioned above, it is preferred that the present shutters comprise non-metal stiles that are free of a separate support member. As used herein, the terms “separate support member” refer to one or more pieces that are fitted within or affixed to a stile and extend the entire length, or a substantial part of the entire length, of the stile, and which are intended to stiffen and/or strengthen the stile so that the shutter resists sagging or deformation while mounted. In some embodiments the separate support member is composed of a material that is different than and more rigid than the material of which the stile is primarily composed. Typically, such separate support members are metal and extend substantially the entire length of a plastic stile. When it is said that the present shutters are free of a separate support member, it is meant that the stiles of the present shutter lack such a feature. It is more preferred that the present shutters are free of a separate support member that is metal.

Although the stile louver filler (127) of some embodiments of the present shutter can be of a material that is different from that of which the stile (110) is primarily composed and can extend substantially the entire length of the stile, the stile louver filler is not to be considered a separate support member as that term is used herein, because it is not intended to stiffen the stile to resist sagging or deformation. Rather, it is intended to act as a base into which louver grooves are cut. It is preferred that the stile louver filler of the present invention is composed of a material that is other than metal.

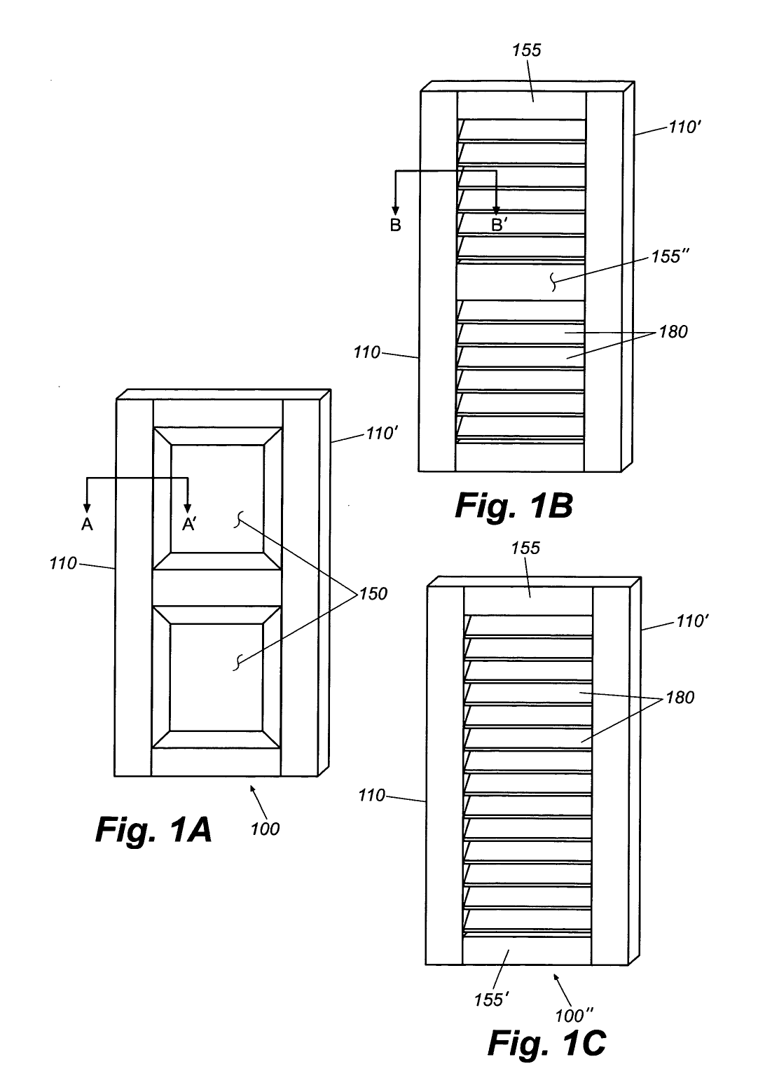

The present shutters can be described with reference to the figures that accompany this specification. In FIG. 1, three types of typical shutter designs are shown. FIG. 1A illustrates a raised panel, or colonial-type, shutter of the present invention (100), having main parts of two vertical spaced apart side members, or stiles (110 and 110′), which are connected together by a central panel (150). If desired, design features, such as grooves, flutes, channels, or other patterns can be machined into, or otherwise formed on one or both sides of the panel (150). For example, in FIG. 1A, the face of the panel (the side facing outward when the shutter is mounted and open), has been milled so that it will have the appearance of a raised panel shutter when assembled.

In FIG. 1B, an example of a louvered shutter of the present invention (100′) is illustrated showing the two stiles (110 and 110′), which are connected together by spaced apart horizontal rails (155, 155′ and 155″) and louvers (180). In FIG. 1C, an example of a Bahama shutter (100″) indicates that it can be constructed with major parts of two stiles (110 and 110′), top and a bottom horizontal rails (155 and 155′) and a plurality of louvers (180) that run between and interconnect the stiles (110 and 110′).

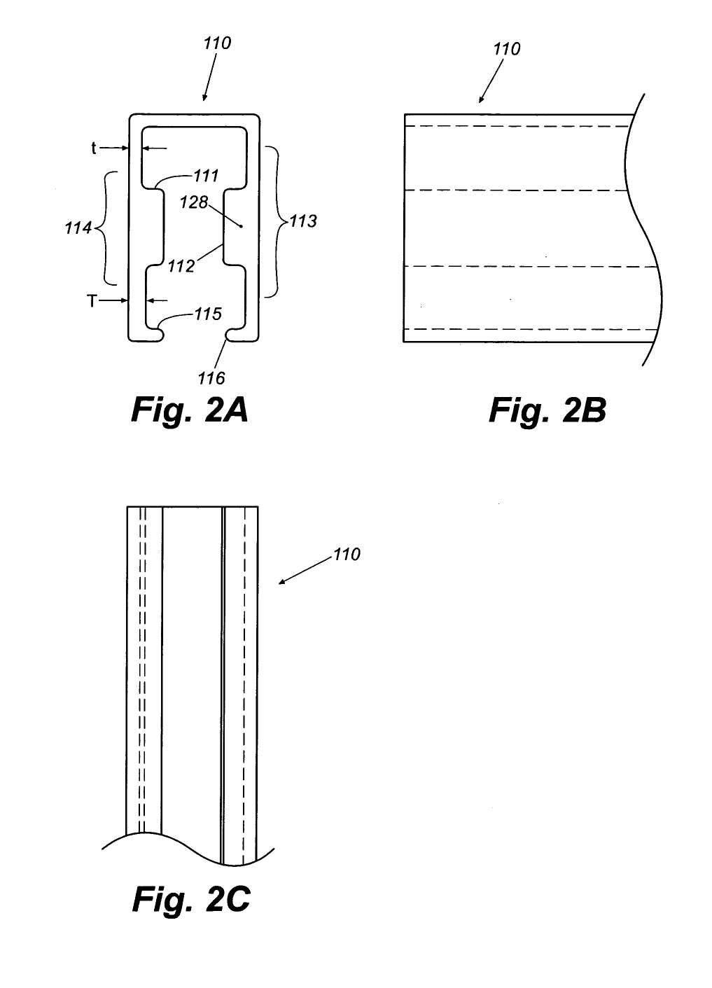

A key part of the present shutter is the stile (110 or 110′) as shown in detail, for example, in FIGS. 2A-2C. In the present shutter, two stiles are used per shutter—one on each side, and the same type of stile member can be used for either side. The present stile (110) preferably comprises a channel member having a cross-section that is roughly “C” shaped with raised projecting internal longitudinal ribs (111) and (112), as shown in FIG. 2A that project into the center of the channel, respectively, from the back wall and the front wall of the stile. The stile also having a front face (113) and a back (114). Designation of a “front” and a “back” of a stile indicates the location of the respective areas when the stile is assembled into a finished shutter. As mentioned above, the “face” or “front” of a shutter faces outward when the shutter is mounted (as beside a window on a building, for example) and opened back onto the side of the building (not covering the window). The “back” of the shutter, on the other hand is the opposite side, or the side of the shutter that faces outward when the shutter is closed to cover the window. The present stile can have a thread, dye string, or other marker embedded into one side of the channel to identify the face or back of the stile. An example of such a marker (128) is shown as an embedded thread in FIG. 2A.

The open side of the “C” shaped channel of a stile (110) has a lip portion (115) that extends from the back of the channel (114) and another lip (116) that extends from the front, or face of the channel (113). The lip portions (115) and (116) extend partially across the thickness of the channel, but preferably do not touch and leave an opening in that side of the channel for insertion of the panel, rails, or louvers. Optionally, a portion of the back wall of the channel (114) can be thicker than the front wall (113) of the channel if desirable. This is shown in FIG. 2A where that portion of the back wall of the channel that is closer to the lip (115) has a thickness of “T“, whereas the front wall of the channel and the remainder of the back wall (other than raised portions 111 and 112) have a thickness of “t”, where “T” is larger than “t”. Although the stile can have any dimensions that are suitable for the particular shutter being constructed, it is preferred that “T” is about 0.175 inches (0.45 cm) and “t” is about 0.125 inches (0.3175 cm).

The stile (110) is not limited to the cross-section design that is shown in the present figures, and may have almost any cross section that will permit it to perform the functions of providing vertical stiffening to the shutter and providing a side terminus for an edge of the central panel (150) or the louvers (180) and/or horizontal rails (155).

The present stile is preferably produced from a material that is durable, fire retardant, rot, insect and corrosion resistant, low-maintenance, and which has good dimensional stability, in particular which resists sagging or bending when raised to high ambient temperatures of, for example, over 100° 0 F. It is preferred that the present stile (110) is free of wood or metal. Although any material having these properties can be used for the present stile, it is preferred that the stile is constructed from fiber reinforced plastic (FRP).

Fiber reinforced plastic (FRP) is known in the art and comprises glass reinforcements in combination with either thermoset or thermoplastic resin systems. If desired, FRP can also incorporate other materials, such as fillers, catalyst, UV inhibitors, and pigments.

It has been found that a preferred type of FRP for use in manufacturing the present stile (110) is pultruded fiberglass. Pultruded fiberglass has a high load capacity, is lightweight (⅓ weight of steel), is flame and fire retardant, non-leaching, requires low maintenance, is resistant to chipping and cracking, is corrosion resistant, and has high dimensional stability (superior stiffness and resistant to sag at high ambient temperatures). Moreover, the material is electrically non-conductive and is non-metallic. As will be discussed below, this same material has also been found to be preferred for the manufacture of louvers (180).

Pultruded fiberglass is a composite of fiberglass reinforcements (fibers and mat) and a thermosetting resin system that is produced by the pultrusion process. In the pultrusion process, a fibrous laminate is pulled through a heated die having a die cavity having the shape of the cross- section of the member that is desired to be formed. The resin sets into the desired shape as it passes through the die and is heated under high pressure. More information can be found at www.bedfordplastics.com Dec. 3, 2004. Manufacturers of pultruded fiberglass products include, for example, San Diego Plastics, Inc., National City, Calif., and

Bedford Reinforced Plastics, Inc., Bedford, Pa.

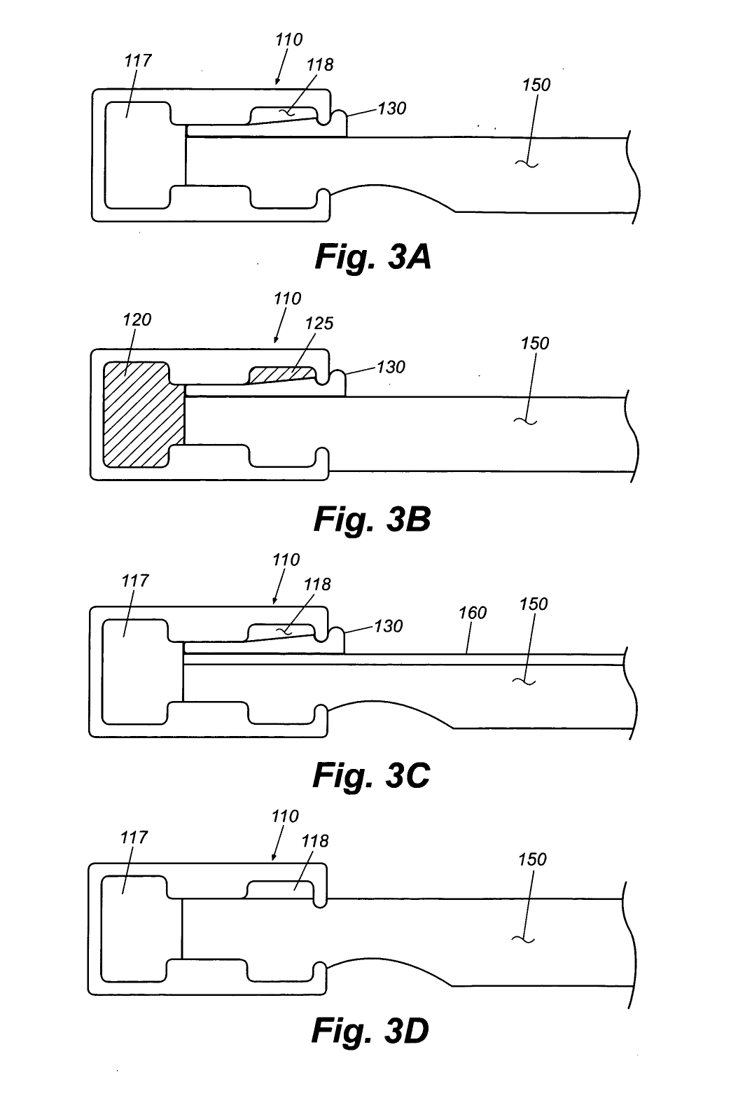

In FIG. 3A and FIG. 3B the stile (110) is shown in cross section at different locations in a raised panel shutter of the present invention. In FIG. 3A, a partial cross section is shown that is representative of a location taken roughly at A-A′, as shown on FIG. 1A. The stile (110) is shown with the panel (150) inserted and locked in place with the stop (130). The areas shown in FIG. 3A as (117) and (118) can be left vacant or, optionally, can be filled. In FIG. 3A and FIG. 3B, the face of the shutter is at the bottom of the figure and the back of the shutter is at the top.

In FIG. 3B, a corner of an end of the shutter is shown, and illustrates the presence of a stile screw support filler (120) that has been used to fill space (117), as well as a stile lip end filler (125) that has been used to fill space (118). The fillers have roughly the cross sections that are shown in the figures and can be of any length, but are preferably between about 0.5″ (1.3 cm) and about 12″ (30.5 cm) long, more preferably, they are between about 1″ (2.54 cm) and about 5″ (12.7 cm) long. The fillers can be made of any material, but preferably are plastic, more preferably are cellular or foamed plastic, even more preferably cellular or foamed plastic with a dimensionally stable filler, and yet more preferably are wood filled cellular polyvinylchloride (PVC).

Alternative configurations of shutters of the present design are illustrated in FIG. 3C and FIG. 3D. In FIG. 3C, a partial cross-section of a raised panel shutter shows how a durable panel (160) can be incorporated into the shutter. Such a durable panel could be used to increase the strength of the shutter and to improve resistance to hurricane damage, for example. A durable panel of this sort could be made of metal, fiberglass, Lexan®, or the like, as will be discussed in more detail below.

In FIG. 3D, an optional design is shown in which a raised panel lock (130) is not required. In this embodiment, the lips of the stile itself are designed to snap into matching grooves in the panel thereby locking the panel into the stile. It is preferred that some type of adhesive is used to secure the panel in the stiles when this type of construction is used. One example of a suitable adhesive that can be used for the assembly of the present shutter is Titebond® construction adhesive, available from Franklin International, Columbus, Ohio.

In the present raised panel shutters, the central panel (which can be referred to herein as the “panel”) (150) can be made of any material having suitable properties, but the panel is preferably plastic, more preferably are cellular or foamed plastic, even more preferably cellular or foamed plastic that includes a dimensionally stable filler, and yet more preferably are wood filled cellular polyvinylchloride (PVC). The panel can be one-piece, or can be laminated from two or more thicknesses of material.

Cellular plastics (which may also be referred to herein as foamed plastics) have reduced density and weight, relative to unfoamed plastic of the same material, and typically provide reduced materials cost. Cellular plastics can be made from such polymers as polystyrene, acrylonitrile-butadiene-styrene copolymer (ABS), acrylic ester modified styrene acrylonitrile terpolymer (ASA), styrene-acrylonitrile polymer (SAN), polyvinylchloride (PVC), polypropylene (PP), and polyethylene (PE). Cellular PVC is preferred.

It is also preferred that the panel (150) of the present shutter be made from a cellular or foamed plastic with a dimensionally stable filler, more preferred is a cellular or foamed plastic with wood filler, and yet more preferred is the use of a cellular wood filled PVC. Such cellular wood filled PVC material is available in the form of boards, or any other desired shape, from several manufacturers. For example, materials such as InteCel PW are suitable for use in the present shutter and are available from World-Pak Div. of Inteplast Group, Ltd., Lolita, Tex. InteCel PW is PVC composite foam sheet, integral skin PVC foam board with a hard glossy surface. Alternative materials that are of similar nature include Daytona Board, which is available from Piedmont Plastics, Inc., Charlotte, N.C., and DuraBoard, which is available from South Asia Plastics Group, Ltd., Scarborough, Ontario, Canada. The material has a low expansion/contraction rate, is water and chemical resistant, fire retardant, durable, lightweight, does not splinter, is processable (can be routed, drilled, sawed and glued like wood using most conventional equipment and adhesives, and is printable and paintable. InteFoam and IntePro are other wood filled foamed plastic board products of World-Pak Div. of Inteplast Group Ltd.

Other manufacturers of cellular filled plastic materials include, for example, Amesbury Group; Plastic Profiles Div., Cannon Falls, Minn., and CertainTeed Corp, Jackson, Mich. An example of a company that supplies technology for the manufacture and use of cellular filled plastics is Extrutech, Costa Mesa, Calif. Further information on the availability and use of cellular filled plastics can be found at www.plasticstechnology.com/articles/200107fa2/, Dec. 3, 2004.

An advantage of the present shutter design is demonstrated in that it makes more efficient use of commercially available materials of standard size. In particular, most shutters for home use on windows are somewhat over 16″ in width. Since a standard width of a wood filled cellular PVC board is 48″, it is normally possible to get only two shutter panels from a standard sheet. This is because shutters using a conventional fabrication technique, such as that shown in U.S. Pat. No. 6,470,639, for example, require that the cellular PVC board extends over the complete width of the shutter. In contrast, because of the use of the present stiles (110), the panel (150) can be up to 1¾″ narrower than the total width of the shutter. This makes it possible to produce three standard shutters from a 48″ wide board of cellular wood filled PVC, rather than two, resulting in a great savings in materials.

As briefly discussed above, if desired, a design can be formed into the face of the shutter. In one embodiment, computer numerical control (CNC) milling can be used to form the design on the front surface of the panel of a raised panel shutter. CNC milling equipment can be obtained from several manufacturers; examples include Bridgeport, Leicester, England, UK, Gildemeister, DMG Charlotte, Inc., Charlotte, N.C., and Koan Cho Machinery, Taichung City, Taiwan.

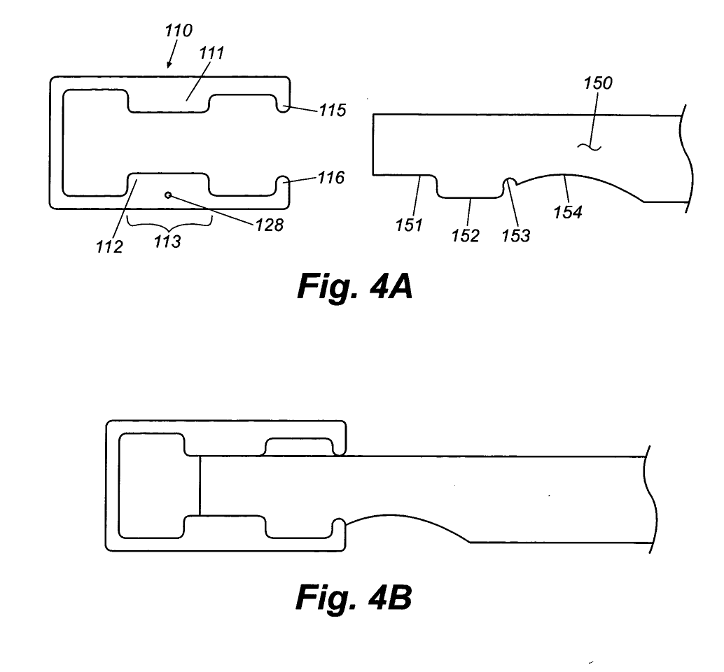

At the same time that a design is being formed into the face of the panel (15), as described above, the edges of the panel that will engage the stiles (110 and 110′) can be formed to mate with the internal geometry of the stile to fully or partially lock the panel to the stile. This can be described with reference to FIG. 4, where the A view shows a stile (110) and a partial cross-section of an edge of a panel (150) taken at a location indicated by A-A′ in FIG. 1A, where the pieces are prior to being joined. At the edge of the panel, a channel (151) has been formed to contact and engage raised section (112), a section (152) having a profile to fit into the section of the stile immediately behind lip (116) at the front of the stile has been formed, a groove (153) to engage lip (116) has been formed, and a channel (154) has been formed to define the front outline of one of the raised panel sections of the front of the panel (150). If the panel is sufficiently thick to engage both lips (115 and 116) of the stile, thereby locking the panel to the stile without the use of a stop (130) then a groove (not shown) can be cut into the back of the panel to engage lip 115.

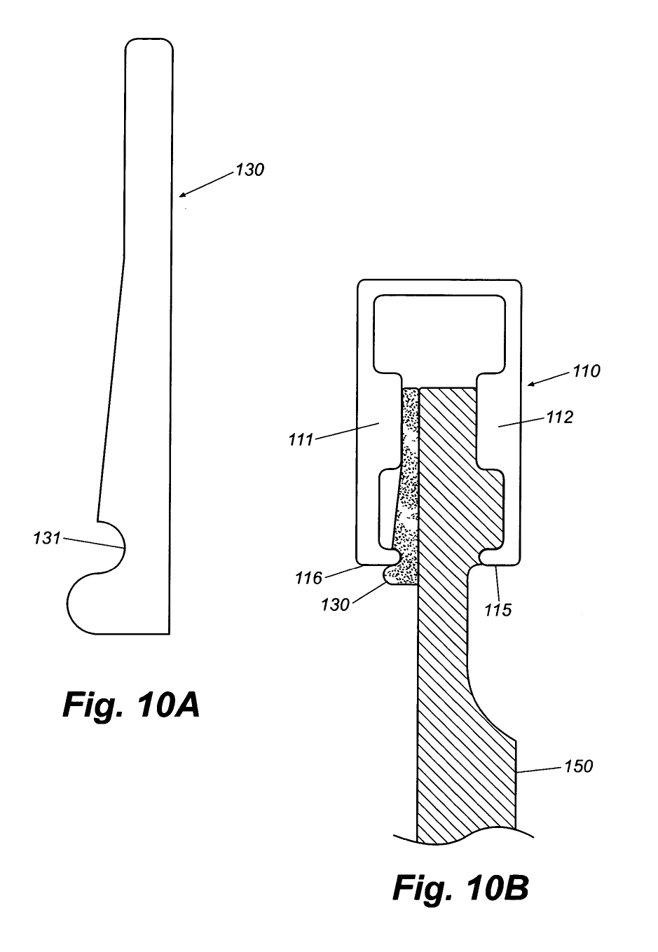

An optional feature of the present shutter is the stop (130). With reference to FIGS. 10A and 10B, a cross-section of the stop is shown in FIG. 10A, and a partial cross section of the stop as installed in a raised panel shutter of the present invention is illustrated in FIG. 10B. As is apparent from the figures, the stop is designed to lock an edge of the panel (150) in place into the stile (110) by working in conjunction with the lips (115 and 116) and the raised areas (111 and 112) of the stile (110), which fit into matching grooves cut into the edge of the panel and the stop (131). The stop can be made of any suitable material, but is preferably made of durable plastic, a more preferably of either a filled plastic or pultruded fiberglass, as those materials have been described herein. The stop (130) can be of any length up to the entire length of the shutter, or it can be present in two or more sections, which can abut, or be spaced apart along the length of the shutter.

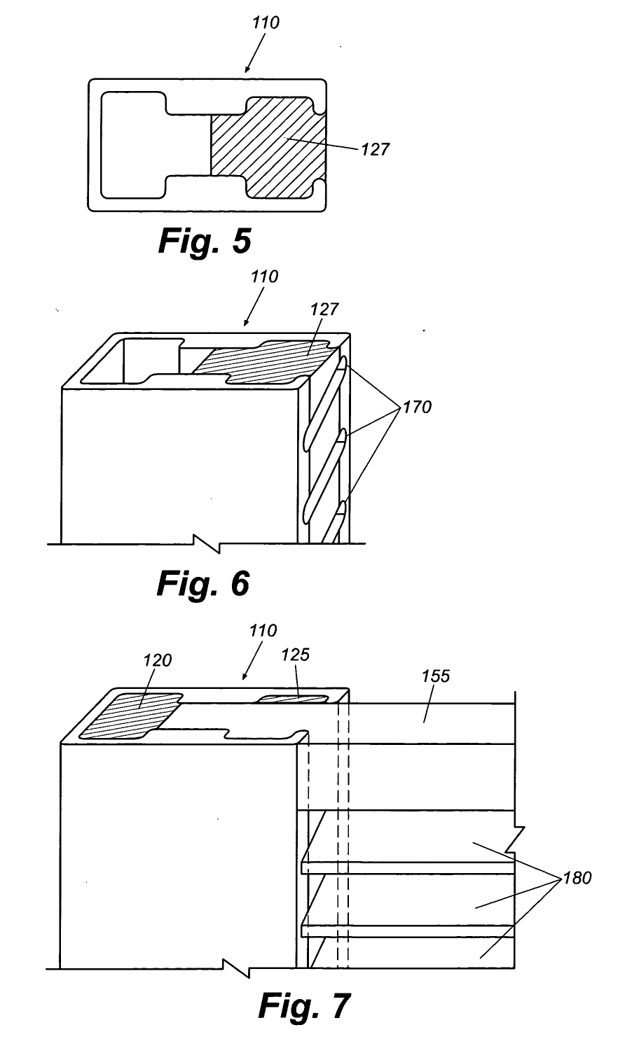

Another feature of the present invention is that the same stile design (110) can be used for the manufacture of louvered and Bahama shutters as well as raised panel shutters. In FIGS. 5, 6, and 7, certain details of the use of the present stile (110) in one embodiment of a Bahama or louvered shutter are illustrated. FIG. 5 shows a partial cross section of a stile (110) fitted with a stile louver filler (127) for use in a louvered or Bahama shutter. The stile louver filler (127) can be made of any suitable material, but is preferably made of the same type of material that is used for the stile screw support filler (120). The stile louver filler (127) can run the entire length of the stile (110), or it can run between any rails (155) that are desired at the top, bottom, or middle of the shutter. It is preferred that the stile louver filler (127) is present at any location along the stile (110) where a louver (180) is to be placed.

In order to accommodate louvers (180) in the stile (110), louver grooves (170) are cut into the stile and stile louver filler, as indicated in FIG. 6, with a louver groover (or louver mortiser). The use of such a piece of equipment is well known in the art for this purpose. To assemble the Bahama or louvered shutter, rails (155) and louvers (180) are glued into place as shown in FIG. 7, and stile screw support fillers (120) and lip end fillers (125) are inserted to finish the ends of each stile.

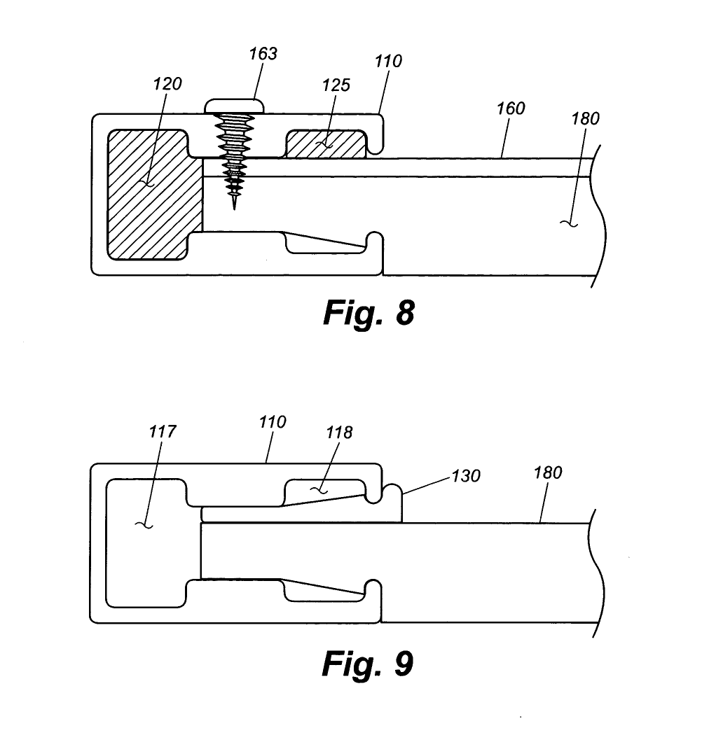

Alternative configurations of louvered or Bahama shutters of the present invention are shown in FIG. 8 and FIG. 9. In FIG. 8, a cross-section of one side of a shutter is shown in which a louver (180) has been pre-cut at one end to snap into the side channel of a stile (110). If desired, a panel (160) can be added to the back of the shutter so that the shutter can have the appearance of a louvered or Bahama shutter, but can function as a storm shutter. A screw (163) can optionally be used to secure the assembly together.

FIG. 9 illustrates the use of a louver (180) having a pre-cut end for snapping in place into the stile (110) as described just above, but which is fixed in place by the insertion of a stop (130). The optional panel (16) is not shown in this view.

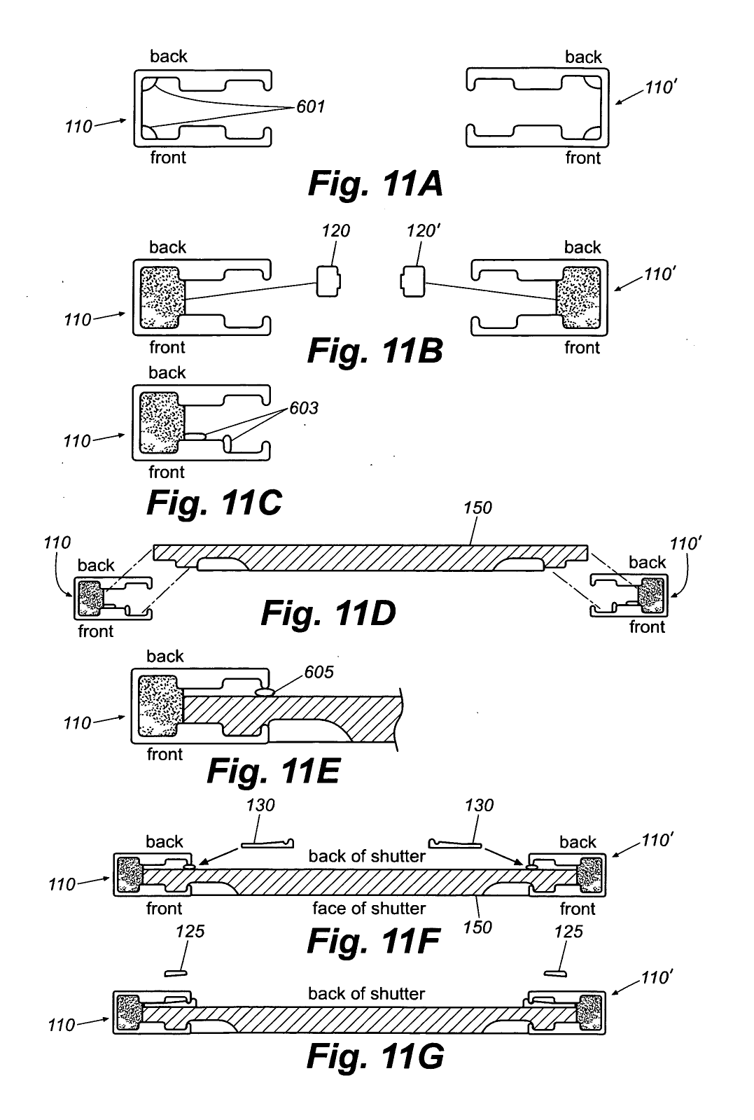

The method of producing a shutter of the present invention is considered to be included in the invention. An embodiment of this method, as applied to the production of a raised panel shutter, can be described with reference to FIG. 11. There, FIGS. 11A-11G illustrate steps in the production process. FIG. 11A illustrates step A of the process, FIG. 11B illustrates step B, and the like. In step A, two stiles (110 and 110′) are cut to the length that is desired for the shutter. Also, a panel (150) is cut from a board of InteCel PW, or Daytona Board of the desired thickness. A panel can be about ¾″ thick and can be composed of a single piece of board, or from two ⅜″ thick boards laminated together, or the like.

Designs to represent the desired number and location of raised panels and rails are then machined into the face of the panel. This machining is typically done with a CNC milling machine. The milling also produces ridges and grooves along each edge of the panel that is to engage a stile. The ridges and grooves are designed to mate with the interior ribs and grooves of the stile, as shown, for example, in FIG. 4A.

With reference to step A of FIG. 11, beads (601 and 601′) of Titebond® construction adhesive are run onto the stiles (110 and 110′) along a part of the interior surfaces of space (117), and preferably at the locations along the stile where mounting hinges will be placed. A stile screw support filler (120 or 120′) is then inserted into each end of each stile to contact the adhesive, as shown in step B. The stile screw support filler (120) is inserted into the stile (110) to a depth so that an end of the filler (120) is flush with the end of the stile (110), as shown, for example, in FIG. 7.

Next, beads of adhesive (603) are applied to the interior of the front side of each stile as shown in step C so that the adhesive will contact the front edge of the panel (150) when it is inserted into the stile.

The two stiles are positioned for insertion of the panel (150), and the panel is inserted into each stile so that the machined ridges and grooves of the panel (150) mate with the interior ribs and grooves of the stile (110), as shown in step D. The stiles (110 and 110′) are applied to each side of the panel (150).

A bead of adhesive (605) is then applied to the lip extending from the back of the panel (115), as shown in step E, and a raised panel stop (130) is inserted into the stile between the panel (150) and the lip extending from the back of the panel (115) until it locks into place by mating with the lip (115), as shown in step F.

When a stop (130) has been inserted along the length of each stile, the main components of the shutter are in place. The shutter is finished by inserting and gluing into place stile lip end fillers (125) into each end of each stile to fill voids (118), as shown in step G. The shutter assembly is now complete and the shutter is ready for the attachment of mounting hardware, if such is required.

Louvered and Bahama shutters of the present invention can be assembled in a similar manner, but with changes made as discussed above for the insertion of rails (155) and louvers (180) in place of the panel (150).

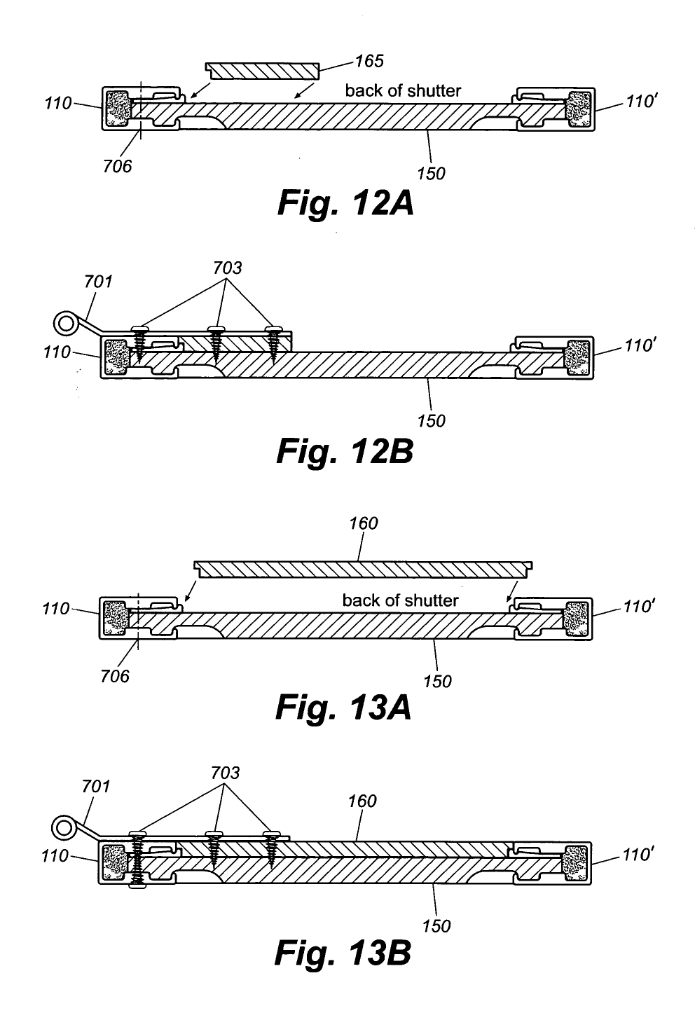

As mentioned above, the present shutter can easily accommodate features that increase its resistance to wind damage, such as in hurricanes or violent storms. One such feature is illustrated in FIG. 12, where hurricane bars are incorporated into a raised panel shutter. In this embodiment, bushings (706) are inserted into holes drilled into the stiles (110 and 110′). The bushings can be placed in one or both stiles and serve to strengthen hinge-mounting hardware or shutter closure latches. A hurricane bar (165) is positioned along on the back of the shutter one edge of a stile (commonly the stile on which hinges are to be installed), as shown in FIG. 12A. Bolts and/or screws (703) can be used to attach a hinge (701) to the shutter, as shown in FIG. 12B. The hurricane bar can be of any stiff and durable material, and is commonly made of steel or other metal.

If desired, a full protective panel (160) can be placed to cover the entire back of the panel (150) of a shutter, as shown in FIG. 13. In one embodiment, a protective panel (160) is positioned across the back of the shutter as shown in FIG. 13A. The panel can be secured to the panel by adhesive, or by bolts, screws, or the like, or any combination thereof. Bolts and/or screws (703) can be used to attach a hinge (701) to the shutter, as shown in FIG. 13B.

The protective panel (160) can be of any durable material. Examples of such materials include a metal, such as steel, iron, brass, bronze, aluminum, or any alloy of any of them; a rigid board material such as a pressed fiberboard, of which Masonite® is one example; a woven or non-woven fabric; fiberglass with or without reinforcing fibers; Plexiglass®; plastic; or any combination thereof. The panel can extend within the stiles (110 and 110′) as shown in FIG. 3C and FIG. 8, for example, or it can abut, but not extend into the stiles, as shown, for example, in FIG. 13B.

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions by those of ordinary skill in the art without departing from the scope of the invention, it is intended that all matter contained in the above description and shown in the accompanying drawings shall be interpreted as illustrative and not in a limiting sense. In addition it should be understood that aspects of the various embodiments may be interchanged both in whole or in part.

What is claimed is:

1. A shutter comprising two stiles that are spaced apart and a plurality of louvers and/or one or more panels or rails that interconnect the stiles.

2. The shutter according to claim 1, wherein the stiles are non-metal stiles.

3. The shutter according to claim 1, wherein each of the two stiles is composed of a fiber reinforced plastic.

4. The shutter according to claim 1, wherein each of the two stiles is composed of pultruded fiberglass.

5. The shutter according to claim 1, comprising a panel that is composed of a cellular plastic that is filled with a dimensionally stable material.

6. The shutter according to claim 5, wherein the panel is composed of wood filled cellular PVC.

7. The shutter according to claim 5, wherein the shutter further comprises a stop, a stile screw support filler, and a stile lip end filler.

8. The shutter according to claim 7, wherein the stop, the stile screw support filler, and the stile lip end filler are composed of wood filled cellular PVC.

9. The shutter according to claim 1, wherein each of the two stiles is free of a separate support member.

10. The shutter according to claim 1, wherein each of the two stiles is free of a metal separate support member.

11. The shutter according to claim 1, comprising a plurality of louvers that interconnect the two stiles.

12. The shutter according to claim 11, further comprising one or more rails that interconnect the two stiles.

13. The shutter according to claim 12, wherein the louvers are composed of fiber reinforced plastic.

14. The shutter according to claim 12, wherein the louvers are composed of pultruded fiberglass.

15. The shutter according to claim 1, further comprising a hurricane bar or a protective panel.

16. The shutter according to claim 15, wherein the protective panel comprises a rigid translucent material.

17. The shutter according to claim 15, wherein the protective panel comprises fiberglass.

18. The shutter according to claim 15, wherein the protective panel comprises a woven or non-woven fabric.

19. A shutter consisting essentially of two spaced apart stiles which are interconnected by a plurality of louvers and/or one or more panels or rails.

20. A method of making a shutter comprising the steps:
providing two stiles each having the length that is planned for the shutter;
providing a panel having the length that is planned for the shutter and a width that is less than that planned for the shutter;
affixing a stile along each side of the panel with an adhesive.

21. The method according to claim 20, further comprising locking the panel to each stile by inserting a stop between the panel and each stile.

22. The method according to claim 21, further comprising inserting a stile screw support filler and a stile lip end filler into each end of each stile to fill voids having matching cross section.

23. A method of using one or more shutters as described in claim 1 for the protection of an opening in a building, the method comprising mounting to the building one or more of said shutters in a position so that they can be closed to cover the opening.
